(19) United States
(12) Patent Application Publication
(10) Pub. No.: US 2026/0369950 A1
(43) Pub. Date: Nov. 19, 2026

(54) TWINAX CONNECTOR ASSEMBLY

(71) Applicant: Molex, LLC, Lisle, IL (US)

(72) Inventors: JOHN C. LAURX, Aurora, IL (US); Khang Choong Yong, Singapore (SG); Jose J. Gonzalez, Jr., Joliet, IL (US); Marc E. Krause, Darien, IL (US); Matthew William Cox, Naperville, IL (US)

(21) Appl. No.: 19/487,920

(22) PCT Filed: May 24, 2024
(86) PCT No.: PCT/IB2024/055054

§ 371 Date: Nov. 25, 2025

Related U.S. Application Data
(60) Provisional application No. 63/468,812, filed on May 25, 2023.

(51) Int. Cl. H01R 43/28; H01R 4/02; H01R 4/70; H01R 13/6586; H01R 13/6591; H01R 43/02

(52) U.S. Cl. CPC H01R 43/28; H01R 4/023; H01R 4/70; H01R 13/6586; H01R 13/65915; H01R 43/02

(57) ABSTRACT

A method for forming a connector assembly and a connector assembly are described. A twinax cable comprising a first conductor and a second conductor is provided, where a portion of the first conductor and a portion of the second conductor are exposed. The portion of the first conductor and the portion of the second conductor are each coined, trimmed, and coupled to a wafer assembly having a multitude of terminal pairs. Tail contacts of terminals of the terminal pairs are substantially planar and positioned to have an offset relative to the first conductor and the second conductor of the twinax cable. The tail contact of each terminal is coupled to and substantially overlaps with the portion of a respective conductor of the twinax cable as exposed, coined, and trimmed.

### RELATED APPLICATIONS

This application claims the benefit of and priority to U.S. Provisional Patent Application No. 63/468,812 filed May 25, 2023, entitled “TWINAX CONNECTOR ASSEMBLY,” the contents of which being incorporated by reference in their entirety herein.

### BACKGROUND

The amount of data processed by computers, computing systems, and computing environments continues to increase. For example, data centers can include hundreds of computing and networking systems interconnected using copper cables, optical cables, and various connectors, cable assemblies, and related terminations between them. The data throughput of these interconnects is high and increasing. A range of cable and connector assemblies are available to facilitate the data interconnect applications, such as board-to-board, wire-to-wire, and wire-to-board applications. An example wire-to-board connector assembly includes a free-end connector that is attached to one or more wires or cables and a fixed-end connector that is attached to a board. A wide range of suitable designs exist for each type of data interconnect application, depending on the requirements and the environment in which the cable and connector assemblies are used.

For applications where high data rates are needed and physical space is restricted, competing concerns make the design of cable and connector assemblies more challenging. High data rate applications often rely upon differentially coupled signal pairs in which two conductors are electrically coupled and physically arranged in pairs to transmit a differential signal. Differential signaling provides greater resistance to spurious signals and electronic crosstalk, among other benefits, and preferably maintains sufficient signal spacing to avoid inadvertent signaling modes with adjacent signals pairs. In the connector interface, ground terminals can be added to create a return path to electrical ground and to provide shielding between differential pairs.

Evolving system architectures require a balance of signal density, signal integrity (SI) performance, and cost. Shorter channels provide lower costs and space savings by utilizing smaller cables, such as twinax cables of a small gauge. Longer channels require larger gauge twinax cables in order to minimize signal loss. Connector systems now need to accommodate various wire gauges in order to optimize systems for cost and performance. Adapting consistent connector structures for various wire gauges while maintaining stringent performance levels can be challenging and costly.

### TECHNICAL FIELD

This disclosure relates to the field of connectors and, more specifically, to connectors suitable for use in high data rate applications.

### BRIEF SUMMARY

In a first aspect, a method for forming a connector assembly includes providing a twinax cable comprising a first conductor and a second conductor, exposing a portion of the first conductor and a portion of the second conductor, coining the portion of the first conductor and the portion of the second conductor as exposed, trimming the portion of the first conductor and the portion of the second conductor as coined, and coupling the portion of the first conductor and the portion of the second conductor as exposed, coined, and trimmed to a wafer assembly.

The portion of the first conductor and the portion of the second conductor as modified (e.g., as exposed, coined, and trimmed) is a coined-and-trimmed portion. The first conductor includes an exposed portion separate from the coined-and-trimmed portion, where the exposed portion is not subject to the coining and trimming. Likewise, the second conductor comprises an exposed portion separate from the coined-and-trimmed portion, where the exposed portion is not subject to the coining and trimming.

Trimming the portion of the first conductor and the portion of the second conductor can include trimming an interior side of the first conductor and the portion of the second conductor, thereby forming a projection on each of the first conductor and the second conductor, the projection of the first conductor and the second conductor facing one another. Trimming the portion of the first conductor and the portion of the second conductor can include trimming both interior and exterior sides of the first conductor and the portion of the second conductor, thereby forming a projection on both the interior and the exterior sides of the first conductor and the second conductor.

Coupling the portion of the first conductor and the portion of the second conductor to the wafer assembly can include welding (e.g., ultrasonic or standard welding) or soldering the portion of the first conductor and the portion of the second conductor to the wafer assembly. The wafer assembly can include various terminal pairs, where each of the terminal pairs are disposed in a U-channel of a U-shield. Each terminal of the terminal pairs can include a lead contact, a tail contact, and a body portion extending between the lead contact and the tail contact. The tail contact of each terminal of the terminal pairs can be substantially planar, and the tail contact can be positioned to have a vertical offset relative to the first conductor and the second conductor.

The tail contact of each terminal of the terminal pairs can be coupled to and substantially overlap the portion of a respective conductor of the twinax cable as exposed, coined, and trimmed. The first conductor and the second conductor as modified can be positioned vertically with respect to the tail contact of each terminal of the terminal pairs. The tail contact of each terminal of the terminal pairs can be disposed in a first U-channel of a first U-shield, and the body portion of each terminal of the terminal pairs can be disposed in a second U-channel of a second U-shield, where the second U-shield and the first U-shield are separate from one another.

The wafer assembly can further include a ground shield formed of a conductive material. The ground shield can include, for example, the first U-shield and the second U-shield that are formed integral with one another. The ground shield can further include a support end configured to retain a body of the twinax cable.

In a second aspect, a connector assembly includes a wafer assembly and a twinax cable. The twinax cable includes a first conductor and a second conductor. A first exposed portion of the first conductor and a second exposed portion of the second conductor are each coined, trimmed, and coupled to the wafer assembly. The first exposed portion of the first conductor and the second exposed portion of the second conductor as modified can each include a coined-and-trimmed portion. The first conductor can include an exposed portion separate from the coined-and-trimmed portion, where the second conductor comprises an exposed portion separate from the coined-and-trimmed portion. The first exposed portion of the first conductor and the second exposed portion of the second conductor can be welded or soldered to the wafer assembly.

The wafer assembly can include various terminal pairs, where each of the terminal pairs can be disposed or otherwise positioned in a U-channel of a U-shield. As noted above, each terminal of the terminal pairs can include a lead contact, a tail contact, and a body portion extending between the lead contact and the tail contact. The tail contact of each terminal of the terminal pairs can be substantially planar, and the tail contact can be positioned to have a vertical offset relative to the first conductor and the second conductor. The tail contact of each terminal of the terminal pairs can be coupled to and substantially overlap the portion of a respective conductor of the twinax cable as modified. The first conductor and the second conductor as modified can be positioned vertically with respect to the tail contact of each terminal of the terminal pairs.

The tail contact of each terminal of the terminal pairs can be disposed in a first U-channel of a first U-shield, and the body portion of each terminal of the terminal pairs can be disposed in a second U-channel of a second U-shield. The second U-shield can be separate from the first U-shield. To this end, the wafer assembly can include a ground shield formed of a conductive material, where the ground shield includes the first U-shield and the second U-shield formed integral with one another. The ground shield can further include a support end configured to retain a body of the twinax cable.

In some aspects, the coined-and-trimmed portion of the first exposed portion of the first conductor and the second exposed portion of the second conductor each includes a curved distal end configured to nest in a region of the wafer assembly and a projection positioned on an interior sidewall of each of the first conductor and the second conductor, wherein the projection of the first conductor and the second conductor face one another. In some aspects, the coined-and-trimmed portion of the first exposed portion of the first conductor and the second exposed portion of the second conductor each includes a curved distal end configured to nest in a region of the wafer assembly and a projection positioned on an interior sidewall and an exterior sidewall of each of the first conductor and the second conductor.

In some aspects, the twinax cable is a 29 AWG twinax cable, and the tail contact of each terminal of the terminal pairs is configured to engage with a 26 AWG twinax cable. It is understood, however, that other cable sizes and cable characteristics can be employed without deviating from the spirit of the present disclosure.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a top perspective view of a connector assembly having variable-sized twinax cables and terminal pairs according to various embodiments of the present disclosure.

FIG. 2 is a bottom perspective view of the connector assembly of FIG. 1 according to various embodiments of the present disclosure.

FIG. 3 is a front perspective view of the connector assembly of FIG. 1 with a shroud thereof omitted from view according to various embodiments of the present disclosure.

FIG. 4 is an enlarged, rear perspective view of the connector assembly of FIG. 1 with the shroud hidden from view according to various embodiments of the present disclosure.

FIG. 5 is an enlarged, rear perspective view of the connector assembly of FIG. 1 with the shroud and a termination block omitted from view according to various embodiments of the present disclosure.

FIG. 6 is a top view of the connector assembly of FIG. 1 with the shroud, the termination block, and a wire support hidden from view according to various embodiments of the present disclosure.

FIG. 7 is a top perspective view of the connector assembly of FIG. 1 with the shroud, the termination block, and the wire support hidden from view according to various embodiments of the present disclosure.

FIG. 8 is an enlarged view of a termination region of a wafer assembly according to various embodiments of the present disclosure.

FIG. 9 is a top perspective view of the connector assembly showing a pairlet overmold that encapsulates the termination region according to various embodiments of the present disclosure.

FIG. 10 is a flowchart illustrating an example method of forming a termination region of a wafer assembly according to various embodiments of the present disclosure.

FIG. 11 is a perspective view of a twinax cable having a multitude of conductors, where the conductor have exposed portions according to various embodiments of the present disclosure.

FIG. 12 is a perspective view of the twinax cable of FIG. 11 where portions of the conductors have been coined or flattened according to various embodiments of the present disclosure.

FIG. 13 is a perspective view of the twinax cable of FIG. 12 where portions of the conductors have been trimmed according to various embodiments of the present disclosure.

FIG. 14 is a perspective view of the twinax cable of FIG. 13 where portions of the conductors are shown for coupling to a terminal pair according to various embodiments of the present disclosure.

FIG. 15 is a perspective view of a twinax cable where portions of the conductors are shown for coupling to a terminal pair according to various embodiments of the present disclosure.

FIG. 16 is an enlarged view of a termination region of a wafer assembly including the twinax cable of FIG. 15 according to various embodiments of the present disclosure.

### DETAILED DESCRIPTION

The present disclosure relates to a connector assembly for implementation in a cable-to-cable connector, hermaphroditic connector, and like connector systems. Cable and connector assemblies are typically designed to meet both mechanical and electrical requirements. To achieve the desired mechanical and electrical requirements, such connectors often incorporate a plurality of wafer assemblies that support a plurality of electrically conductive terminals. The wafer assemblies are typically enclosed and supported by connector housings, and a range of sizes, shapes, and styles of connector housings are available for different interconnect applications. In some cases, it is desirable to mate a wafer assembly to a twinax cable.

Conventionally, twinax cables include signal conductors that are exposed by removing insulation. The signal conductors are then positioned to corresponding connector terminals of a wafer assembly prior to fixed attachment. Connector termination characteristics include, but are not limited to, signal width and spacing, shield width and spacing, conductor width and spacing, and so forth. These connector termination characteristics can alter signal integrity performance of a connector or associated device. For instance, changing a gauge of a twinax cable impacts precise signal-related relationships and subjects the connector to performance degradation and/or component changes. Transmission channel requirements, however, require increased conductor size of a twinax cable in order to lower channel loss.

Accordingly, various embodiments are described for performing material reduction on twinax signal conductors to manage signal integrity performance of a termination and utilize identical connector components as that of a smaller gauge twinax cable. To this end, a connector assembly is described that can be used with a multitude of gauges (e.g., American Wire Gauges (AWGs)) of twinax cables. For instance, the connector assembly can be utilized with 26 AWG twinax cables, 28 AWG twinax cables, or other sized twinax cables. Material reduction may enable, for example, a larger gauge twinax cable to be adapted for use in a connector termination designed for a smaller gauge twinax cable. Additionally, the material reduction as described herein offers signal integrity crosstalk advantages due to a reduced signal cross-section, thereby allowing for a tighter shield wall spacing than would be permitted without material reduction. Further, tooling and development costs can be reduced due to fewer unique components required for twinax cable conversion.

In context of the foregoing, a method for forming a connector assembly is described that includes providing a twinax cable comprising a first conductor and a second conductor, exposing a portion of the first conductor and a portion of the second conductor, coining the portion of the first conductor and the portion of the second conductor, trimming the portion of the first conductor and the portion of the second conductor, and coupling the portion of the first conductor and the portion of the second conductor as exposed, coined, and trimmed to a wafer assembly. Trimming may include trimming one or more sides of the first conductor and/or the second conductor.

Coupling the portion of the first conductor and the portion of the second conductor to the wafer assembly can include welding (e.g., ultrasonic or standard welding) or soldering the portion of the first conductor and the portion of the second conductor to the wafer assembly. The wafer assembly can include various terminal pairs, where each of the terminal pairs are disposed in a U-channel of a U-shield. Each terminal of the terminal pairs can include a lead contact, a tail contact, and a body portion extending between the lead contact and the tail contact. The tail contact of each terminal of the terminal pairs can be substantially planar, and the tail contact can be positioned to have a vertical offset relative to the first conductor and the second conductor.

The tail contact of each terminal of the terminal pairs can be coupled to and substantially overlap the portion of a respective conductor of the twinax cable as exposed, coined, and trimmed. The first conductor and the second conductor as modified can be positioned vertically with respect to the tail contact of each terminal of the terminal pairs. The tail contact of each terminal of the terminal pairs can be disposed in a first U-channel of a first U-shield, and the body portion of each terminal of the terminal pairs can be disposed in a second U-channel of a second U-shield, where the second U-shield and the first U-shield are separate from one another.

The wafer assembly can further include a ground shield formed of a conductive material. The ground shield can include, for example, a first U-shield portion and a second U-shield portion that are formed integral with one another. The ground shield can further include a support end configured to retain a body of the twinax cable.

Additionally, in some embodiments, a connector assembly is described that includes a wafer assembly and a twinax cable. The twinax cable includes a first conductor and a second conductor. A first exposed portion of the first conductor and a second exposed portion of the second conductor are each coined, trimmed, and coupled to the wafer assembly. The first exposed portion of the first conductor and the second exposed portion of the second conductor as modified can each include a coined-and-trimmed portion. The first conductor can include an exposed portion separate from the coined-and-trimmed portion, where the second conductor can include an exposed portion separate from the coined-and-trimmed portion. The first exposed portion of the first conductor and the second exposed portion of the second conductor can be welded or soldered to the wafer assembly.

The wafer assembly can include various terminal pairs, where each of the terminal pairs can be disposed or otherwise positioned in a U-channel of a U-shield. As noted above, each terminal of the terminal pairs can include a lead contact, a tail contact, and a body portion extending between the lead contact and the tail contact. The tail contact of each terminal of the terminal pairs can be substantially planar, and the tail contact can be positioned to have a vertical offset relative to the first conductor and the second conductor. The tail contact of each terminal of the terminal pairs can be coupled to and substantially overlap the portion of a respective conductor of the twinax cable as modified. The first conductor and the second conductor as modified can be positioned vertically with respect to the tail contact of each terminal of the terminal pairs.

The tail contact of each terminal of the terminal pairs can be disposed in a U-channel of a first U-shield portion, and the body portion of each terminal of the terminal pairs can be disposed in the U-channel of a second U-shield portion. The second U-shield portion can be separate from the first U-shield portion. To this end, the wafer assembly can include a ground shield formed of a conductive material, where the ground shield includes the first U-shield portion and the second U-shield portion that can be formed integral with one another. The ground shield can further include a support end configured to retain a body of the twinax cable.

In some embodiments, the twinax cable is a 29 AWG twinax cable, and the tail contact of each terminal of the terminal pairs is configured to engage with a 26 AWG twinax cable. It is understood, however, that other cable sizes and cable characteristics can be employed without deviating from the spirit of the present disclosure.

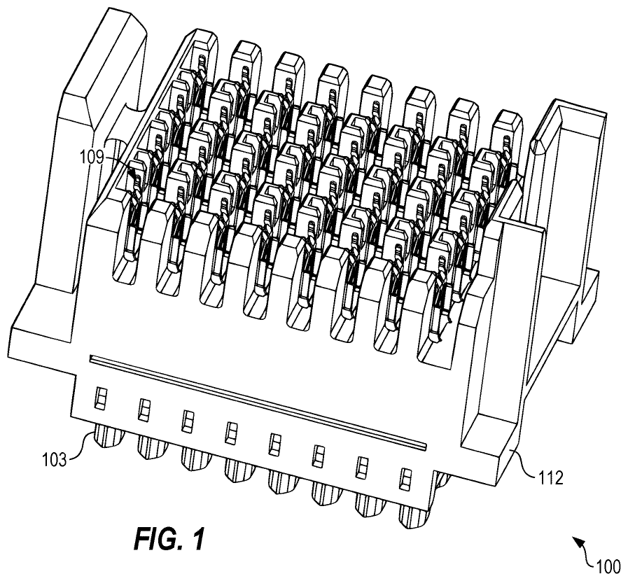

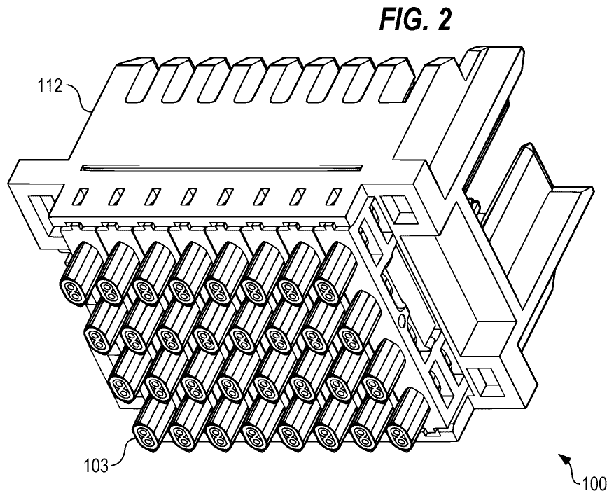

Turning now to the figures, FIG. 1 shows a top perspective view of a connector assembly 100 and FIG. 2 shows a bottom perspective view of the connector assembly 100 according to various embodiments. Referring to FIGS. 1 and 2 collectively, the connector assembly 100 can include a multitude of twinax cables 103 that are terminated to a wafer assembly 106, where the wafer assembly 106 includes a multitude of terminal pairs 109. Only representative portions of the twinax cables 103 are shown, as can be appreciated. The connector assembly 100 further includes a shroud 112 that protects and retains the terminal pairs 109 and other components of the connector assembly 100 in a compact arrangement. The shroud 112 can be formed of a non-conductive material, such as a polymer or plastic. The connector assembly 100 is an example of a hermaphroditic cable-to-cable connector, although the concepts described herein are not limited to cable-to-cable connector systems or any particular type or style of interconnect system.

For applications where high data rates are needed and physical space is restricted, competing concerns make the design of the connector assembly 100 more challenging. High data rate applications often rely upon differentially coupled terminal pairs 109 in which two conductors are electrically coupled and physically arranged in pairs to transmit a differential signal. Differential signaling provides greater resistance to spurious signals and electronic crosstalk, among other benefits, and preferably maintains sufficient signal spacing to avoid inadvertent signaling modes with adjacent signals pairs. In the connector interface, ground terminals can be added to create a return path to electrical ground and to provide shielding between differential pairs, as will be described.

Evolving system and connector architectures can require a balance of signal density, signal integrity performance, and cost. Shorter channels can take advantage of the lower cost and space of a twinax cable 103 of a smaller gauge, whereas longer channels can require larger twinax cables 103 of a larger gauge to minimize signal loss. It is desirable for the connector assembly 100 to accommodate various gauges of twinax cables 103 in order to optimize systems for cost and performance. Adapting consistent connector structures for various wire gauges while maintaining stringent performance levels can be challenging and costly. Accordingly, the connector assembly 100 can include a termination region, as will be described, where signal conductors of the twinax cables 103 are attached (e.g., welded) to connector terminals.

Each of the twinax cables 103 can include a cable having a multitude of conductors, such as a single conductor, two conductors, three or more conductors, etc., where each conductor can be employed in accordance with the material reduction embodiments described herein. The shape, size, proportion, and other characteristics of the twinax cables 103 can vary as compared to that shown. For example, the gauge of the conductors in the twinax cables 103 can vary, among other characteristics of the twinax cables 103. As examples, the twinax cables 103 can be 24 AWG cables, 26 AWG cables, 28 AWG cables, 30 AWG cables, and so forth, and can have varying characteristics and be formed of varying materials. The twinax cables 103 can include two conductors, as shown in the example of FIGS. 1-13.

A first conductor can be terminated and electrically coupled to a first terminal of a terminal pair 109, whereas a second conductor can be terminated and electrically coupled to a second terminal of the terminal pair 109, as will be shown and described. Each of the terminal pairs 109 can be formed from (e.g., stamped, sheared, or otherwise formed out of) a flat sheet of metal, such as a lead frame. In some cases, the sheet of metal or lead frame can be plated with one or more plating metals. The plating metals can be selectively plated such that a highly-conduct material (e.g., silver or copper) can be applied to only a select portion of a terminal or other component of the lead frame, reducing an overall cost of the connector assembly 100 or individual components thereof. The shroud 112 can be formed from a plastic, such as liquid crystal polymer (LCP), polyethylene (PE), polytetrafluoroethylene (PTFE), fluoropolymer, or other plastic or insulating material(s).

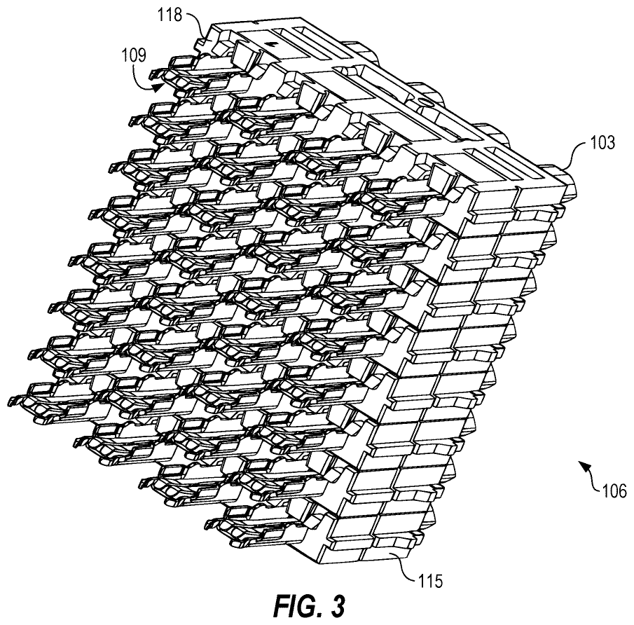

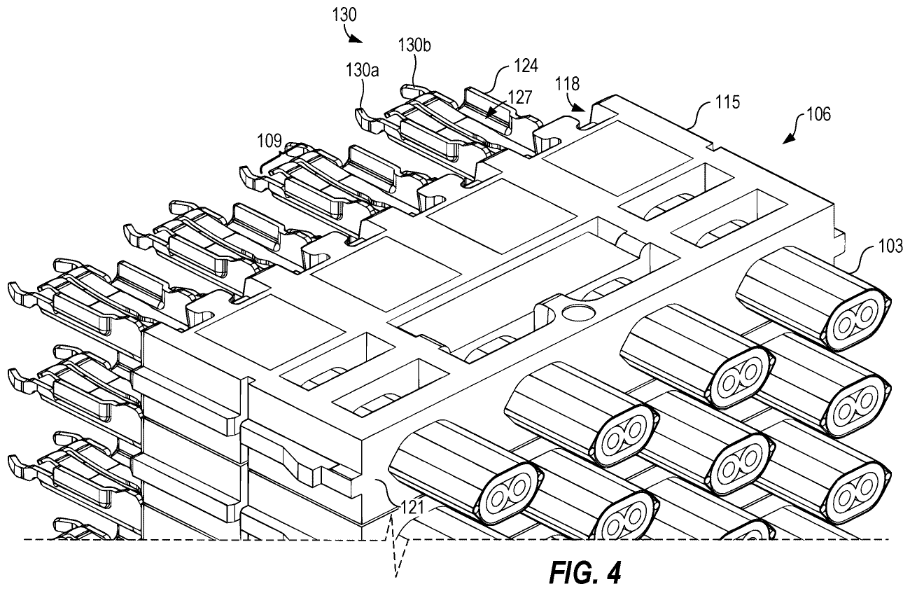

FIGS. 3 and 4 show front and rear perspective views of the wafer assembly 106, respectively, where the shroud 112 of the connector assembly 100 is not shown for explanatory purposes. By virtue of the shroud 112 being omitted, various columns and rows of terminal pairs 109 are displayed. For instance, in the embodiment of FIGS. 3 and 4, the wafer assembly 106 includes an 8×4 matrix of terminal pairs 109. It is understood, however, that other arrangements of terminal pairs 109 can be employed.

Further, the wafer assembly 106 includes a multitude of individual wafers or cable alignment blocks 115 that retain and support a row of terminal pairs 109, twinax cables 103, and associated components. Each cable alignment block 115 can be formed of a non-conductive polymer material, although other types of materials can be employed. While the cable alignment block 115 of FIG. 3 is shown supporting four terminal pairs 109, it is understood that the cable alignment block 115 can support other numbers of terminal pairs 109.

To support wafer assemblies 106, each cable alignment block 115 can include a multitude of apertures that extend from a front face 118 of the cable alignment block 115 to a rear face 121 of the cable alignment block 115, thereby securing portions of the terminal pairs 109 and the twinax cables 103 therein. The twinax cables 103 can terminate to the terminal pairs 109 within the cable alignment block 115 through insertion in the apertures. Moreover, the cable alignment block 115 can encapsulate and protect a termination region, as will be described. This can protect the connector assembly 100, and the components thereof, during mating of the connector assembly 100 with another connector (not shown).

Referring to FIG. 4, the cable alignment block 115 of the wafer assembly 106 includes a ground shield 124 for each terminal pair 109 that defines a channel, such as a U-channel 127. The ground shield 124 can include a U-shield, as shown in FIG. 4. Thus, the terminal pairs 109 can be disposed in a respective one of the U-channels 127 such the ground shield 124 reduces signal interference and improves signal integrity. The ground shield 124 thus provides broad-side coupling to the terminal pairs 109, provides a return path for ground, and helps shield the terminal pairs 109 from adjacent terminal pairs in a same or adjacent wafer.

In some embodiments, the ground shield 124 includes ground terminals 130a, 130b (collectively “ground terminals 130”) that are formed integral with the ground shield 124. Due to a tendency to have the terminals of the terminal pairs 109 located relatively close to each other, terminal pairs 109 can be separated from adjacent pairs of differential signal terminals by one or more ground terminals 130 and/or a ground shield 124.

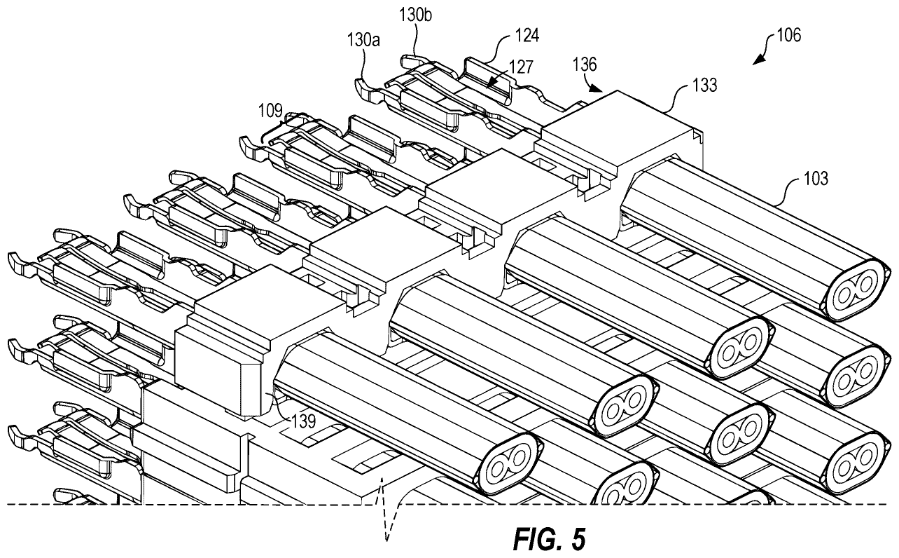

Turning now to FIG. 5, a rear perspective view of the wafer assembly 106 is shown, where the shroud 112 and the cable alignment block 115 of the connector assembly 100 are omitted for explanatory purposes. The wafer assembly 106 can further include a multitude of organizers 133. The organizers 133 can be positioned within or underneath the cable alignment blocks 115. Like the cable alignment block 115, each organizer 133 can include a multitude of apertures that extend from a front face 136 of the organizer 133 to a rear face 139 of the organizer 133, and the cable alignment block 115 can be formed of a polymer material in some embodiments.

The twinax cables 103 can terminate to the terminal pairs 109 within the organizers 133 through insertion in the apertures. Thus, the organizer 133 can further encapsulate and protect a termination region, as will be described. This can protect the connector assembly 100, and the components thereof, during mating of the connector assembly 100 with another connector (not shown). Additionally, the organizers 133 can prevent lateral movement that can affect a connection between the twinax cables 103 and the terminal pairs 109, thereby causing signal degradation and connector failure.

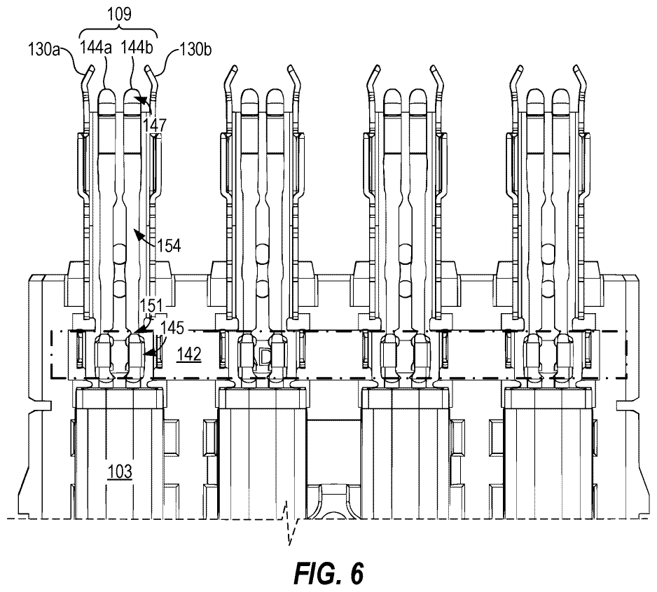

Referring next to FIGS. 6, 7, and 8, a top view, a perspective view, and an enlarged terminal view of the wafer assembly 106 are shown respectively, according to various embodiments. Notably, the shroud 112, the cable alignment block 115, and the organizer 133 are omitted from these views, thereby exposing a termination region 142 in which the twinax cables 103 terminate or otherwise couple to the terminal pairs 109.

Referring to FIGS. 6-8 collectively, each terminal pair 109 of the wafer assembly 106 can include terminals 144 or, more specifically, a first terminal 144a and a second terminal 144b. The first terminal 144a and the second terminal 144b can each include a lead contact 147, a tail contact 151, and a body portion 154 extending between the lead contact 147 and the tail contact 151, as can be appreciated. The tail contact 151 can be exposed or uncovered in the termination region 142 such that conductors of the twinax cable 103 can terminate with the tail contact 151 of a respective terminal 144 of the terminal pair 109.

Each of the terminals 144 of the terminal pairs 109 can be formed from (e.g., stamped, sheared, or otherwise formed out of) a flat sheet of metal, such as a lead frame. In some cases, the sheet of metal or lead frame can be plated with one or more plating metals. The organizers 133, the cable alignment blocks 115, and other wafer moldings can be formed from a plastic, such as LCP, PE, PTFE, fluoropolymer, or other plastic or insulating material(s) and can be molded around the terminal pairs 109. In one example, the organizers 133 and/or the cable alignment blocks 115 can be molded around the terminal pairs 109 before the terminal pairs 109 are cut or sheared away from a larger lead frame. The terminals 144 of the terminal pairs 109 can be physically and electrically separated from each other in the wafer assembly 106.

The twinax cable 103 can include a jacket, braid, insulating dielectric material, and conductors 145 or, more specifically, a first conductor 145a and a second conductor 145b in embodiments in which the twinax cable 103 includes two conductors 145. The first conductor 145a and the second conductor 145b can each include an exposed portion 148 where the jacket, braid, insulating dielectric, and/or other material of the twinax cable 103 is not present or has been removed. The exposed portion 148, as formed of conductive material, can be coupled to the tail contact 151 through welding, soldering, or like connection. As shown in FIGS. 6, 7, and 8, the exposed portion 148 of the first conductor 145a and the exposed portion 148 of the second conductor 145b are each coined, trimmed, and coupled to the wafer assembly 106 via the tail contact 151, as will be described.

In this example, 26 AWG signal conductors 145 are coined and trimmed to be compatible with that of a 29 AWG twinax connection. As the 26 AWG signal conductors 145 have roughly twice the conductor volume of the 29 AWG conductors 145, maintaining the proper impedance and equivalent crosstalk performance in the same form factor is challenging without material reduction. With material reduction, crosstalk and impedance can be effectively managed, and minimal modifications to the base connector components are required.

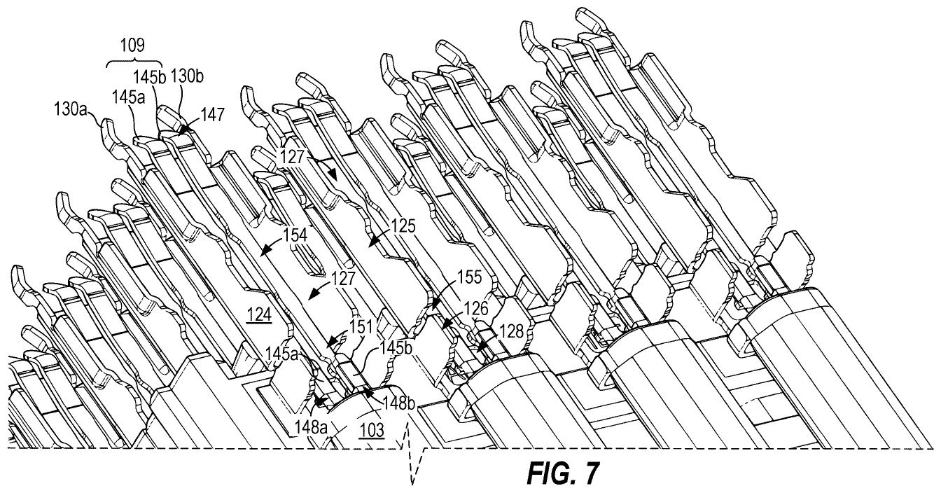

Referring specifically to FIG. 7, the wafer assembly 106 can further include the ground shield 124. The ground shield 124 can include, for example, a first U-shield portion 125 and a second U-shield portion 126 that are formed integral with one another. For instance, the first U-shield portion and the second U-shield portion 126 can be formed through bending to create sidewalls. The ground shield 124 can further include a support end 128 configured to retain a body of the twinax cable 103. Together, the first U-shield portion 125 and the second U-shield portion 126, acting as sidewalls, can define the U-channel 127. The tail contact 151 of each terminal 144 of terminal pairs 109 can be disposed in the U-channel 127 of the second U-shield portion 126, and the body portion 154 of each terminal 144 of the terminal pairs 109 can be disposed in the U-channel 127 of the first U-shield portion 125. The second U-shield portion 126 and the first U-shield portion 125 can be separate from one another. For instance, a notch 155, such as a U-shaped notch, can be positioned between the first U-shield portion 125 and the second U-shield portion 126, which may be sheared or cut during manufacture.

Referring to FIGS. 7, 8, and 9 collectively, the tail contact 151 of each terminal 144 of the terminal pairs 109 can be substantially planar or flat, and the tail contact 151 can be positioned to have a vertical offset relative to the first conductor 145a and the second conductor 145b. The tail contact 152 and the conductors 145 can be oriented parallel with respect to one another. Further, the tail contact 151 of each terminal 144 of the terminal pairs 109 can be coupled to and substantially overlap the portion of a respective conductor 145 of the twinax cable 103, for example, as exposed, coined, and trimmed. The first conductor 145a and the second conductor 145b as modified can be positioned vertically with respect to the tail contact 151 of each terminal 144 of the terminal pairs 109. In some embodiments, a pairlet overmold 169 can be provided that encapsulates or partially encapsulates the termination region 142. For instance, a polymer or other insulator material can be overmolded on the termination region 142. The pairlet overmold 169 may protect respective terminal pairs 109 and ensure integrity of differential signaling.

The first U-shield portion 125 and the second U-shield portion 126 are formed integral with one another, but are separated by notch 155. Additionally, the second U-shield portion 126 has a width greater than a width of the first U-shield portion 125, which can be provided through differential bending or other deformation of the ground shield 124 during manufacture. The size, orientation, and/or positioning of the first U-shield portion 125 and the second U-shield portion 126 can provide signal integrity improvements for the connector assembly 100.

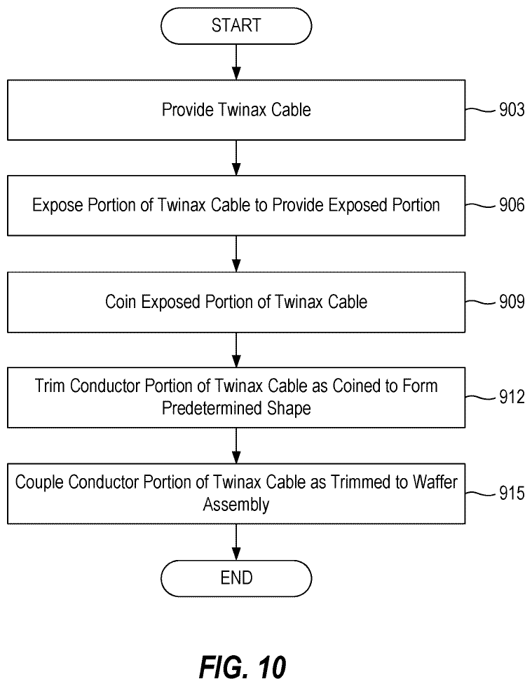

Turning now to FIG. 10, a flowchart 900 is shown describing an example method for forming a connector assembly 100 in accordance with various embodiments. First, at 903, a twinax cable 103 can be provided. The twinax cable 103 can include a cable with two conductors 145 for example, although it is understood that other cables with a single conductor or a multitude of conductors can be employed.

Next, at 906, a portion of the conductor 145 can be exposed to provide an exposed portion 148. This can include cutting, stripping, or otherwise removing a sheath, insulation, or other materials, especially non-conductive materials, that can surround the conductor 145 in the twinax cable 103. Alternatively, the conductor 145 can be formed to have an exposed portion 148 during formation.

At 909, the exposed portion 148 of the twinax cable 103 can be coined. Coining can include positioning the exposed portion 148 in a press that applies pressure to flatten the exposed portion 148 such that the exposed portion 148 has a width wider than a remaining, non-flattened portion of the conductor 145. In other embodiments, the exposed portion 148 can be heated to soften or melt the exposed portion 148 such that the exposed portion 148 has a width wider than a remaining, non-flattened portion of the conductor 145. In other embodiments, a combination of pressure, heat, or other like process can be employed to coin the exposed portion.

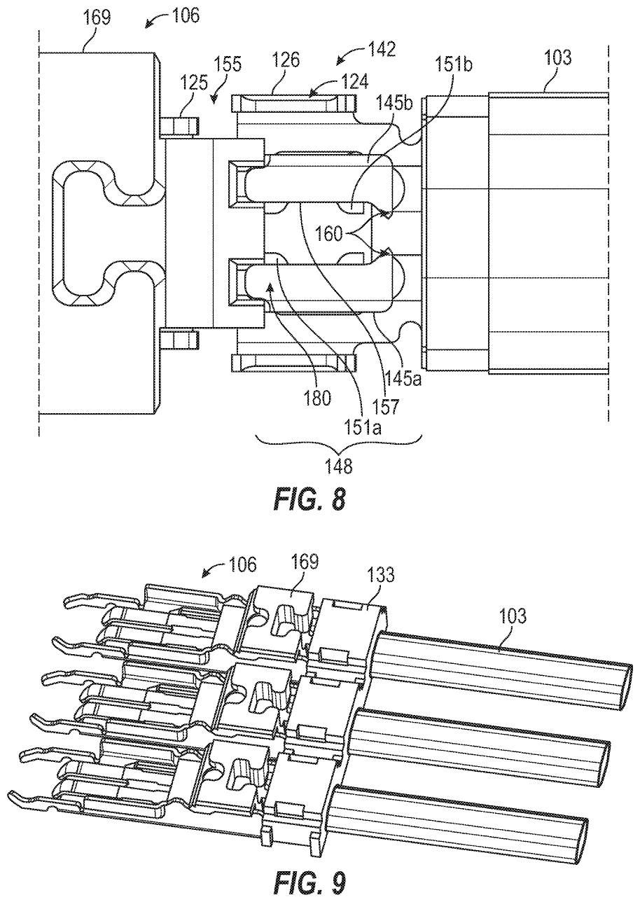

Next, at 912, the exposed portion 148 of the first conductor 145a and the second conductor 145b as coined can be trimmed. Referring back to FIG. 8, trimming can include removing a portion of an interior sidewall 157 of the exposed portion 148. In some embodiments, the portion removed is a J-shaped or L-shaped portion, such that the conductor 145 as trimmed includes a projection 160. As the interior sidewalls 157 are removed from the respective conductors 145, each conductor 145 can include a projection 160 facing one another, as shown in FIG. 8. In other embodiments, both interior and exterior sidewalls 177 of the conductors 145 can be trimmed, creating multiple projections 160 on each conductor 145, as will be described. As shown in FIG. 8, the projection 160 can include a generally sharp projection in the form of a right, equilateral, or isosceles triangle, or other desired projection shape. The bodies of the conductors 145a, 145b are thus L-shaped or J-shaped. As the projections 160 are positioned proximate to one another, and as other portions of the bodies of the conductors 145a, 145b are further away, improved signal integrity can be provided.

Referring back to FIG. 10, in 915, the process can further include coupling the portion 148 of the first conductor 145a and the second conductor 145b as exposed, coined, and trimmed to a wafer assembly 106. This process can include welding (e.g., ultrasonic welding), soldering, or performing a like connection to couple the exposed portion 148 of a conductor 105 to a tail contact 151 in the wafer assembly 106. Thereafter, the process can proceed to completion.

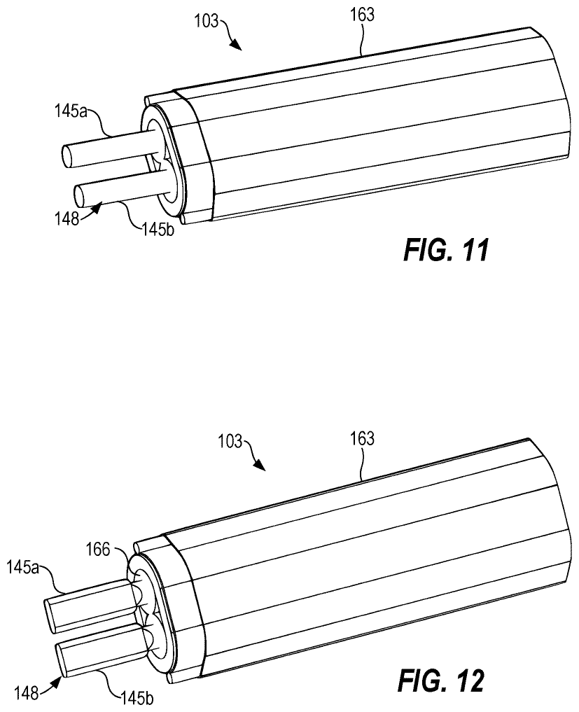

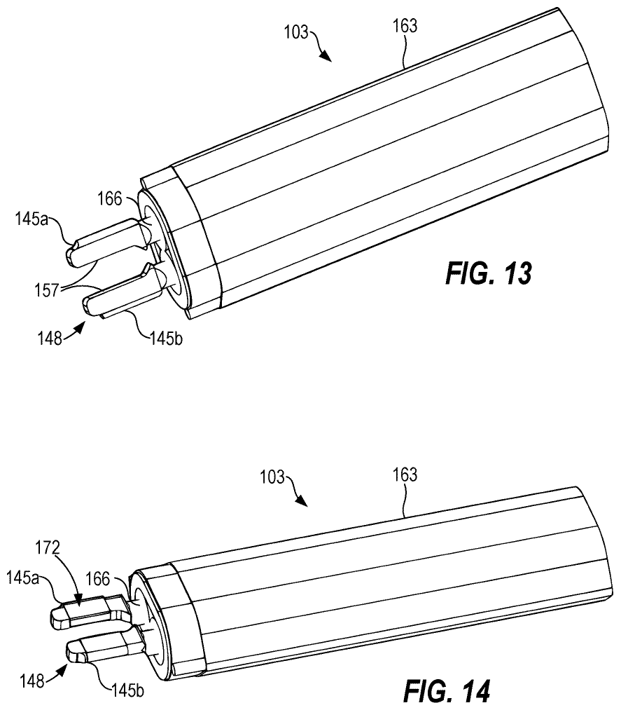

Moving along to FIGS. 11-14, various perspective views of a twinax cable 103 are shown according to various embodiments. Specifically, the process described above with respect to FIG. 10 is shown in sequence where an exposed portion 148 of a conductor 145 of a twinax cable 103 is coined, trimmed, and coupled. FIG. 11 shows exposed portions 148 of conductor 145 of the twinax cable 103, where the exposed portions 148 project from a 163 sheathing or other housing in a cantilevered arrangement. FIG. 12 shows the exposed portions following a coining process, FIG. 13 shows the exposed portions following a trimming process, and FIG. 14 shows the exposed portions as coupled to a wafer assembly 106 (not shown).

As can be seen from FIGS. 11-14, the first conductor 145a and the second conductor 145b each includes an exposed portion 166 separate from the exposed (and coined-and-trimmed) portion 148, where the exposed portion 166 is not subject to the coining and trimming. In some embodiments, the conductors 145, prior to or after modification, can be bent to adjust an angle of the conductors 145 relative to one another. Specifically, with respect to FIG. 14, a stepped region 172 can be formed through welding or other connection process whereby the exposed portion 148 of the conductors 145 is secured to a terminal or other like device.

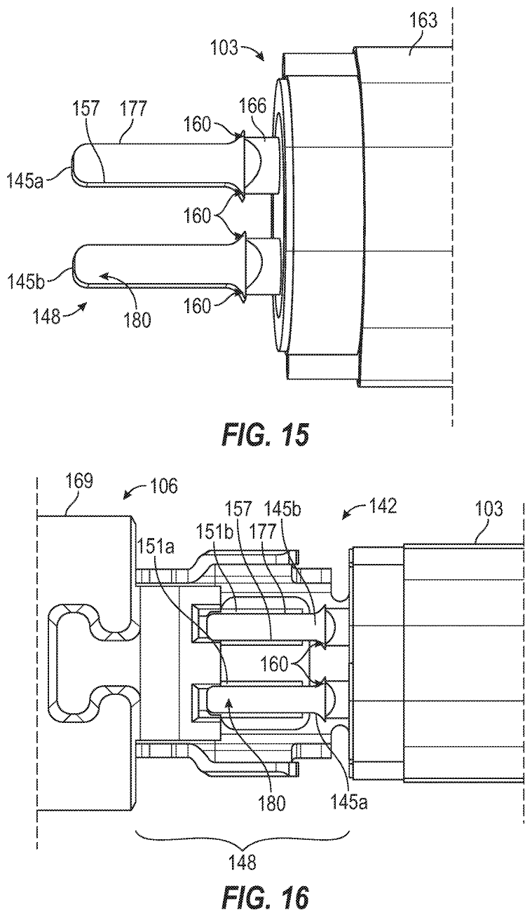

While the embodiments of FIGS. 13 and 14 show a trimming process where an interior sidewall 157 of the conductors 145 facing one another is trimmed or otherwise deformed or removed, in some embodiments, both the interior sidewall 157 and an exterior sidewall 177 of the conductors 145 can be trimmed or otherwise deformed or removed. Referring to FIGS. 15 and 16, examples of conductors 145a, 145b are shown having the interior sidewall 157 and exterior sidewall 177 trimmed and removed such that projections 160 are formed at the base of both the interior sidewall 157 and the exterior sidewall 177. The projections 160 can be triangular in shape due to the sheering process, although other shapes or orientations can be employed.

Accordingly, in some embodiments, as shown in FIG. 8, the coined-and-trimmed portion of the first conductor 145a and the second conductor 145b can include a curved distal end 180 configured to nest in a region of the wafer assembly 106 or the pairlet overmold 169. The projection 160 can be positioned on an interior sidewall 157 of each of the first conductor 145a and the second conductor 145b, where the projection 160 of the first conductor 145a and the second conductor 145b face one another.

In some embodiments, as shown in FIGS. 15 and 16, the coined-and-trimmed portion of the first conductor 145a and the second conductor 145b can each include a curved distal end 180 configured to nest in a region of the wafer assembly 106 or the pairlet overmold 169. Moreover, the coined-and-trimmed portion of the first conductor 145a and the second conductor 145b can each include a projection 160 positioned on an interior sidewall 157 and an exterior sidewall 177 of each of the first conductor 145a and the second conductor 145b.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A method for forming a connector assembly, comprising:
providing a twinax cable comprising a first conductor and a second conductor;
exposing a portion of the first conductor and a portion of the second conductor;
coining the portion of the first conductor and the portion of the second conductor;
trimming the portion of the first conductor and the portion of the second conductor; and
coupling the portion of the first conductor and the portion of the second conductor as exposed, coined, and trimmed to a wafer assembly.

2. The method according to claim 1, wherein:
the portion of the first conductor and the portion of the second conductor as exposed, coined, and trimmed each comprise a coined-and-trimmed portion;
the first conductor comprises an exposed portion separate from the coined-and-trimmed portion, the exposed portion not being subject to the coining and trimming; and
the second conductor comprises an exposed portion separate from the coined-and-trimmed portion, the exposed portion not being subject to the coining and trimming.

3. The method according to claim 1, wherein coupling the portion of the first conductor and the portion of the second conductor to the wafer assembly comprises:
welding or soldering the portion of the first conductor and the portion of the second conductor to the wafer assembly.

4. The method according to claim 1, wherein the wafer assembly comprises a plurality of terminal pairs, each of the plurality of terminal pairs being disposed in a respective U-channel of a U-shield.

5. The method according to claim 4, wherein:
each terminal of the plurality of terminal pairs comprises a lead contact, a tail contact, and a body portion extending between the lead contact and the tail contact;
the tail contact of each terminal of the plurality of terminal pairs is substantially planar, and the tail contact is positioned to have a vertical offset relative to the first conductor and the second conductor; and
the tail contact of each terminal of the plurality of terminal pairs is coupled to and substantially overlaps the portion of a respective conductor of the twinax cable as exposed, coined, and trimmed.

6-8. (canceled)

9. The method according to claim 5, wherein the tail contact of each terminal of the plurality of terminal pairs is disposed in a respective U-channel of a first U-shield portion, and the body portion of each terminal of the plurality of terminal pairs is disposed in the U-channel of a second U-shield portion, the second U-shield being separate from the first U-shield.

10. The method according to claim 9, wherein:
the wafer assembly further comprises a ground shield formed of a conductive material, the ground shield comprising the first U-shield portion and the second U-shield portion formed integral with one another; and
the ground shield further comprises a support end configured to retain a body of the twinax cable.

11. (canceled)

12. The method according to claim 1, wherein trimming the portion of the first conductor and the portion of the second conductor comprises trimming both interior and exterior sidewalls of the first conductor and the portion of the second conductor, thereby forming a projection on both the interior and the exterior sides of the first conductor and the second conductor.

13. A connector assembly, comprising:
a wafer assembly; and
a twinax cable comprising a first conductor and a second conductor, wherein a first exposed portion of the first conductor and a second exposed portion of the second conductor are each coined, trimmed, and coupled to the wafer assembly.

14. The connector assembly according to claim 13, wherein:
the first exposed portion of the first conductor and the second exposed portion of the second conductor as exposed, coined, and trimmed each comprise a coined-and-trimmed portion; and
the first conductor comprises an exposed portion separate from the coined-and-trimmed portion, and the second conductor comprises an exposed portion separate from the coined-and-trimmed portion.

15. The connector assembly according to claim 13, wherein the first exposed portion of the first conductor and the second exposed portion of the second conductor are welded or soldered to the wafer assembly.

16. The connector assembly according to claim 15, wherein the wafer assembly comprises a plurality of terminal pairs, each of the plurality of terminal pairs being disposed in a respective U-channel of a U-shield.

17. The connector assembly according to claim 16, wherein:
each terminal of the plurality of terminal pairs comprises a lead contact, a tail contact, and a body portion extending between the lead contact and the tail contact;
the tail contact of each terminal of the plurality of terminal pairs is substantially planar, and the tail contact is positioned to have a vertical offset relative to the first conductor and the second conductor; and
the tail contact of each terminal of the plurality of terminal pairs is coupled to and substantially overlaps the portion of a respective conductor of the twinax cable as exposed, coined, and trimmed.

18-19. (canceled)

20. The connector assembly according to claim 13, wherein:
the first conductor and the second conductor as exposed, coined, and trimmed are positioned vertically with respect to the tail contact of each terminal of the plurality of terminal pairs; and
the tail contact of each terminal of the plurality of terminal pairs is disposed in a respective U-channel of a first U-shield portion, and the body portion of each terminal of the plurality of terminal pairs is disposed in the U-channel of a second U-shield portion, the second U-shield portion being separate from the first U-shield portion.

21. The connector assembly according to claim 13, wherein:
the wafer assembly further comprises a ground shield formed of a conductive material, the ground shield comprising the first U-shield portion and the second U-shield portion formed integral with one another; and
the ground shield further comprises a support end configured to retain a body of the twinax cable.

22. The connector assembly according to claim 13, wherein the twinax cable is a 29 AWG twinax cable, and the tail contact of each terminal of the plurality of terminal pairs is configured to engage with a 26 AWG twinax cable.

23. The connector assembly according to claim 13, further comprising a plurality of pairlet overmolds formed of an insulator material that protect a termination region of the plurality of terminal pairs.

24. The connector assembly according to claim 14, wherein the coined-and-trimmed portion of the first exposed portion of the first conductor and the second exposed portion of the second conductor each comprises:
a curved distal end configured to nest in a region of the wafer assembly; and
a projection positioned on an interior sidewall of each of the first conductor and the second conductor, wherein the projection of the first conductor and the second conductor face one another.

25. The connector assembly according to claim 14, wherein the coined-and-trimmed portion of the first exposed portion of the first conductor and the second exposed portion of the second conductor each comprises:
a curved distal end configured to nest in a region of the wafer assembly; and
a projection positioned on an interior sidewall and an exterior sidewall of each of the first conductor and the second conductor.

26. The connector assembly according to claim 13, wherein the first exposed portion of the first conductor and the second exposed portion of the second conductor each comprise a stepped region formed through a coupling to the wafer assembly.
